(19) United States
(12) Patent Application Publication
(10) Pub. No.: US 2015/0091251 A1
(43) Pub. Date: Apr. 2, 2015

(54) Ink Pen for Lottery Players with Lottery Ticket Storage, Random Number Selector and Scratch Off Implement

(71) Applicants: Alvin Polk, Chicago, IL (US); Rahman Polk, Chicago, IL (US)

(72) Inventors: Alvin Polk, Chicago, IL (US); Rahman Polk, Chicago, IL (US)

(21) Appl. No.: 14/502,673

(22) Filed: Sep. 30, 2014

Related U.S. Application Data
(60) Provisional application No. 61/885,190, filed on Oct. 1, 2013.

(51) Int. Cl. B43K 29/20

(52) U.S. Cl. CPC B43K 29/20
USPC 273/138.1; 401/195; 29/428

(57) ABSTRACT

The present invention relates to a combined writing and storing instrument to aid lottery players in decision making and lottery ticket collecting. The present invention combines a manual random number generator and a scratching off implement with a writing instrument. A lottery player can record the numbers generated by the manual random number generator using the writing instrument. One or more pieces of paper recording the lottery number selecting information can be stored inside the writing instrument through a longitudinal slot on the body of the writing instrument. Both the manual random number generator and the scratching off implement are located on the cap of the writing instrument. A clip on the cap is capable of clipping the writing instrument to a pocket for the lottery player to carry the writing instrument easily. The ink reservoir of the writing instrument is replaceable for the continued and repeated use of the writing instrument.

This application claims priority of Provisional Application Ser. No. 61/885,190 filed Oct. 1, 2013, to extent allowed by law.

### FIELD OF THE INVENTION

The present disclosure relates to combined writing and storing instruments, and in particular to a writing and storing instrument to be used for playing the lottery.

### BACKGROUND OF THE INVENTION

Various pens have been used as writing implements to apply ink to a surface such as paper. Pens on the market today have designs to impart unique visual appeal or style to the housing that standardized gel ink cartridges are placed within. Most of these designs typically use various materials, shapes, and configurations to establish a unique appearance. Modern types of pens also include ballpoint, rollerball, fountain, and felt or ceramic tip pens.

As a writing instrument, pens are widely used in many aspects of people's daily lives. One aspect of such instruments is to be used when one is playing the lottery. Lottery players use pens to take notes or write down numbers they selected for a certain lottery draw.

The purchase of lottery tickets cannot be accounted for by decision models based on expected value maximization. Lottery players choose number combinations pending a random drawing for a prize which may be a certain amount of money. The chances of winning a lottery jackpot can vary widely depending on the lottery design, and are determined by several factors, including the count of possible numbers, and the count of winning numbers drawn. In a simple 6-to-49 lotto, a player chooses six numbers from 1 to 49 (no duplicates are allowed). If all six numbers on the player's ticket match those produced in the official drawing (regardless of the order in which the numbers are drawn), then the player is a jackpot winner. Matching more numbers, the payout increases.

Other forms of lottery include a scratchcard that is a small card often made of thin paper-based card material, such as cardboard or plastic to conceal PINs, where one or more areas contain concealed information which can be revealed by scratching off an opaque covering. In some cases the entire scratchable area needs to be scratched to determine whether a prize has been won. The card can be printed either to be a winner or not, or to reveal a secret code. The result does not depend on which portions are scratched off. Some other forms of scratchcards do not require the removal of all areas to determine whether the player wins. In a quiz scratchcard, the winner can be determined where the area corresponding to the right answer is scratched.

U.S. Design Pat. USD 379,472 and U.S. Design Pat. USD 377,806 both disclose pens having lottery number selecting functions. The disclosed pens are both combinations of ball-point pen and lottery number selector. The lottery number selectors are both clear transparent hollow spheres containing a predetermined number of smaller numbered beads. The number display portion of the lottery number chooser disclosed in USD 379,472 is a transparent hollow shaft that connects directly to the bottom of the hollow sphere and receives the numbered beads contained in the hollow sphere when the user positions the pen in certain directions. The number display portion of the lottery number selector disclosed in USD 377,806 is a curved transparent tube extending from near the bottom of the hollow sphere. The curved transparent tube number displayer receives the numbered beads inside the hollow sphere when the user positions the pen in certain directions.

The users of the disclosed lottery pens use the numbers on the small balls received by the number displayer to assist their choice of selecting the lottery number combination. The size of the hollow sphere is relatively large and therefore makes it difficult for the user to carry the pen around. Making the hollow sphere smaller will result in the downsizing of the numbered balls contained in the hollow sphere, and the numbers on the balls will be hard to read. Another problem with the disclosed lottery pens is the number of small balls received by the number displayer is predetermined and not subject to change.

U.S. Pat. No. 7,040,829 discloses a combination paper dispenser and pen, and includes a reel tube having a lateral opening and a cavity, a central shaft disposed inside the cavity, a spring set for the shaft with one end inserted and fixed on the central shaft while the other end is connected with the beginning end of the paper reel. The '829 patented device employs the spring set for shaft rotation to release the paper from the reel through the lateral opening, or furl paper on the roll back into the cavity. As shown in FIGS. 1, 5 and 6 in the '829 patent, the paper is pulled out through anticlockwise rotation R1 and the released paper can also be turned around reversely into the dispenser 2 by the inwards pulling force of the clockwise rotation R2.

The '829 patent device illustrates and describes a separable pen and paper dispenser, where the paper dispenser is fabricated to only dispense paper from a roll of paper through a slot, or to retract the dispensed portion of paper through the slot, if the dispensed paper remains connected to the reel of paper. It would be practically impossible to separate a portion of the dispensed paper and then re-insert that separate portion back through the slot. Likewise, it would also be impossible to insert an independent paper or card, such as a lottery ticket, through the dispensing slot and into the chamber at the top of the instrument of the '829 patent.

In addition, in order to insert a new roll of paper into the reel-holding cavity of the '829 device, it is apparent that the housing must be taken apart. In the present invention, individual lottery tickets can be inserted into the ticket holding cavity without dismantling the instrument.

Despite the information and designs disclosed by the prior art references, there is no effective solution for generating random numbers to aid in choosing numbers for playing the lottery, conveniently storing lottery playing slips, and scraping the covered areas from instant game cards using a single writing instrument.

### SUMMARY OF THE INVENTION

It is therefore a primary object of the present invention to provide a random number generator as part of a writing instrument. The random number generator consists of a rotary wheel with numbers on its surface, and a magnifying lens to aid in reading the generated numbers. A scratch off implement is attached to the body of the writing instrument and a chamber in the body of the writing instrument receives tickets around a central shaft to conveniently store papers such as lottery playing slips that are inserted into a slot in the body of the writing instrument.

### BRIEF DESCRIPTION OF THE DRAWINGS

The features of the present invention which are believed to be novel are set forth with particularity in the appended claims. The invention may best be understood from the following detailed description of currently preferred embodiments thereof taken in conjunction with the accompanying drawings wherein like numerals refer to like parts, and in which:

FIG. 1 is a sectional view of the lottery pen of the present invention.

FIG. 2 is a perspective view of the body of the lottery pen of the present invention.

FIG. 3 is a perspective view of the cap portion of the lottery pen of the present invention.

FIG. 4 is an exploded elevation view of the present invention.

### DETAILED DESCRIPTION OF THE INVENTION

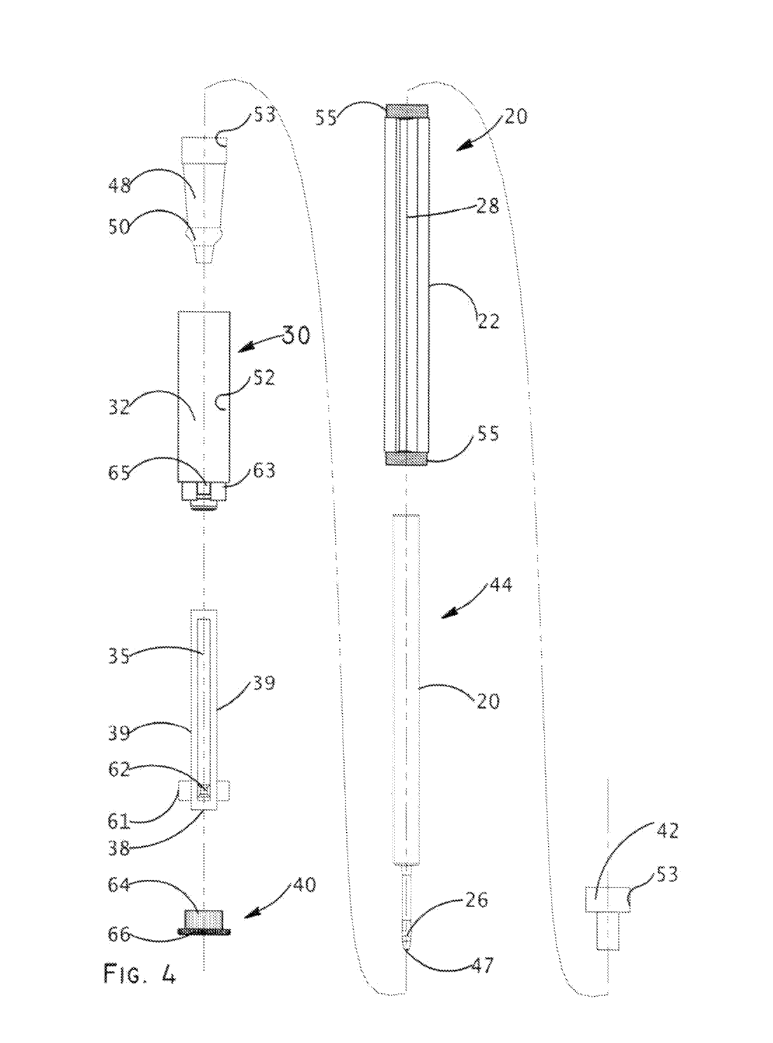

A section view of the lottery pen 10 of the present invention is illustrated in FIG. 1. The lottery pen 10 comprises a central shaft 20 extending longitudinally in tubular outer body 22 and a pen cap 30, also shown in FIG. 3. The outer body 22 and pen cap 30 can be frictionally engaged together through a removable snapping mechanism, as is known in the art.

In the illustrated embodiment, the pen body 20 comprises a tubular outer body 22 that can be cylindrical or other desired shapes. Central shaft 20, as described, extends axially in the outer body 22, and central shaft 20 comprises an ink reservoir 24 and a hollow ink applicator point 26, such as a roller ball, in communication with ink reservoir 24, as is known in the art. Outer body 22 includes an elongated longitudinal ticket slot 28 communicating between the hollow interior of outer body 22 and the exterior of the outer body, for purposes to be explained.

Pen cap 30, shown in FIG. 3, comprises a hollow tubular outer body 32 adapted to removably engage pen outer body 22 as shown at 34 in FIG. 1. A pocket clip 35 is attached at one end 36 to outer body 32, and includes a scratch-off implement 38 at one end of pocket clip 35. The side edges 39 of pocket clip 35 also provide scratch-off edges, as will be explained. Pen cap 30 also includes a manually operable random number generator 40, explained below in more detail.

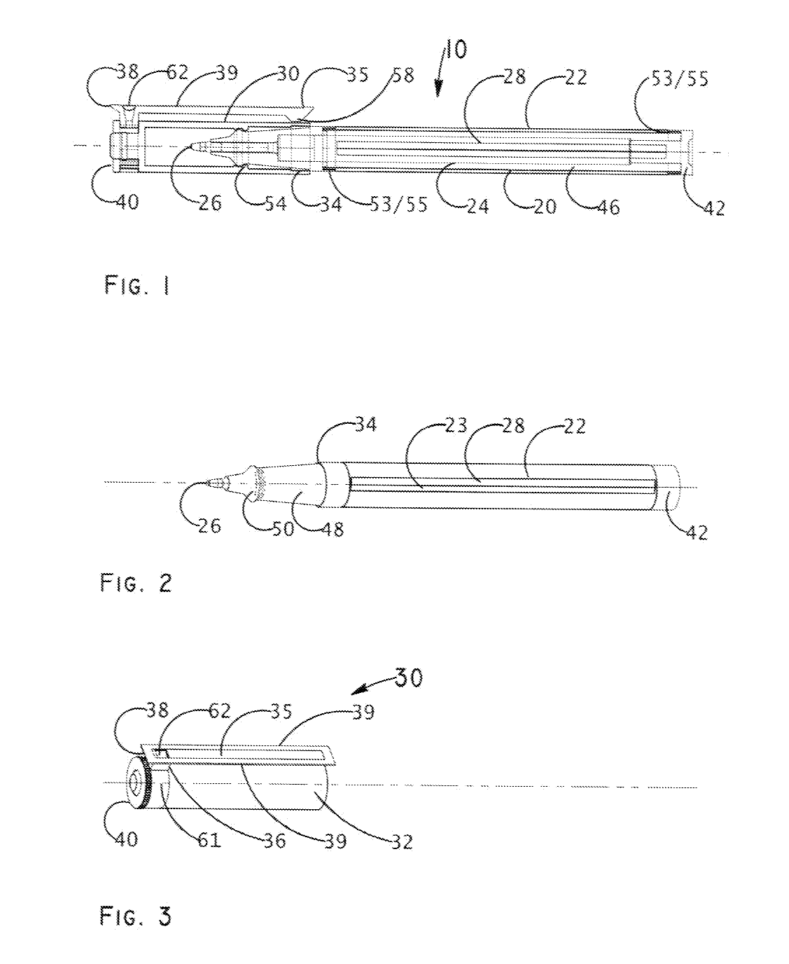

FIG. 4 depicts a detailed exploded elevation view of each part of the present invention. A pen end cap 42 threadingly (or frictionally) engages one end of an opening in the tubular outer body 22 at the top of the lottery pen 10. In the illustrated embodiment, external threads 55 of outer body 22 engage internal threads 53 on end cap 42 and on pen tip holder 48, respectively. The pen end cap 42 closes the outer body 22 at one end to prevent the enclosed objects from falling out of the hollow interior portion of tubular outer body 22, as will be explained. The top portion of outer body 22 presses against central shaft 20 of ink reservoir 24 to maintain the ink cartridge 44 and applicator point 26 in their proper place. Elongated ticket slot 28 is set longitudinally on the outer wall of the outer body 22. The elongated ticket slot 28 is also beveled as shown at 23 in FIG. 2, and is adapted to receive at least one or more lottery tickets or other paper. A storage volume 46 exists between the outer surface of the central shaft 20 and the inner surface of the outer body 22. The storage volume 46 securely stores each lottery ticket when the ticket is inserted into the body of the pen 10. The beveled surface 23 urges paper inserted through slot 28 to curl around ink cartridge 44. The user can retrieve inserted tickets by withdrawing the pen end cap 42 and removing the paper tickets from one end of the tubular outer body 22, or by pulling out the paper from the elongated ticket slot 28, preferably by inserting a small gripping mechanism into the slot 28 to engage each ticket. In the illustrated embodiment, the ink cartridge 44 can be a standard gel or ink refill, as are known in the art. The interior dimensions of end cap 42 may be modified to accept ink cartridges 44 of varying sizes.

The writing instrument comprising central shaft 20 is located in the tubular outer body 22 of the lottery pen 10. The writing instrument comprises an ink reservoir 24 and rollerball end 26. The rollerball end 26 lays down the ink contained in the ink reservoir 24 in an appropriate ratio for the user's intended application, such as marking a lottery card. The ink contained in the ink reservoir 24 includes oil-based ink and water-based ink, as is known in the art.

Upon inserting the lottery tickets, made of paper or thin card material, into the angled or beveled slot 28, the tickets extend into the storage volume 46 (FIG. 1) between the outer surface of central shaft 20 which is part of ink cartridge 44, and the inner surface of tubular outer body 22. The tickets initially wrap or coil around central shaft 20, and the later inserted tickets wrap or coil around the previously inserted lottery ticket. The lottery tickets can later be removed from outer body 22 as described above.

A pen tip holder 48 is set on the bottom end of the outer body 22 over ink applicator point 26. The pen tip holder 48 and central shaft 20 are threadingly or frictionally connected to each other and enclose the ink applicator point 26. The rollerball end 47 of the ink applicator point 26 extends from the bottom end of the pen tip holder 48 in order to contact the writing surface. The central shaft 20 with ink applicator point 26 can be replaced when the ink is drained from the ink reservoir 24, or when the user desires.

A manually removable locking mechanism is provided at the outer surface of the pen tip holder 48 and the inner surface of the pen cap 30. An expanding joint 50 flexibly latches with a mating tapered inner surface 54 of the pen cap 30 (FIG. 1).The locking mechanism can be disengaged when a pulling force is applied, removing the pen cap 30 from the outer body 22. While a snap-lock type of mechanism is shown and described, it is understood that other types of removably locking mechanisms can be used, as are known in the art.

The pen cap 30 is designed to accommodate the pen tip holder 48 and protect the rollerball end of the ink applicator point 26. The pen cap 30 has a hollow chamber formed by inner surface 52 and is open on one end to receive the pen tip holder 48. The other end of the pen cap 30 is closed and adjacent to elongated pocket clip 35. The pocket clip 35 is attached at one end on the outer wall of the pen cap 30 by a friction-fit partial band 61 which attaches clip 35 to pen cap 30 via indented area 63 of pen cap 30. Partial band 61 also locks in place a magnifying lens 62 over number panel 64. The magnifying lens 62 is aligned with the number viewing window 65, which allows the viewing of numbers on the surface 64 through number viewing window 65 in indented area 63. Clip 35 parallels the outer wall of the pen cap 30, and is spaced apart from the pen cap 30 by the spacer 58 (FIG. 1) located at one end of the elongated clip 35. The other end of the elongated clip 35 is a scratch off implement 38 that extends slightly beyond the closed end of the pen cap 30. The scratch off implement 38 is thinner than the elongated clip 35, and is used to scratch off the covering material on a scratch lottery or other card. Additionally, as mentioned previously, side edges 39 of clip 35 also function as scratch-off edges. The clip 35 thus has keen edges along three sides, such that the tip 38 is used to accurately remove small amounts of scratch-off material, while longer sides 39 are for removal of large areas of scratch-off material from a lottery or other game card.

The random number generator 40 displays numbers on its number panel 64 to facilitate the lottery players' number choosing decisions. The number panel 64 rotates when a user spins the knurled wheel 66 connected to the number panel 64 in either a counter clockwise or clockwise direction. The knurled wheel 66 also constitutes the closed end of the pen cap 30. The opening 65 is designed so that only one number at a time will be displayed through the magnifying lens 62 when the number panel 64 stops spinning The user can turn the knurled wheel 66 multiple times, as desired, to determine the combination of numbers they want to use to play the lottery. The user can use the writing instrument 26 to record the displayed numbers when a number is displayed.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural or method elements that do not differ from the literal language of the claims, or if they include equivalent structural elements with insubstantial differences from the literal language of the claims.

What is claimed:

1. A combined writing and lottery ticket storing instrument for lottery players, comprising:
a. a tubular outer body having a tubular chamber defined by the outer body;
b. a central shaft extending longitudinally in said chamber, a storage volume in said chamber created between an outer surface of said central shaft and an inner surface of said outer body;
c. said central shaft including an ink applicator point and an ink reservoir;
d. an elongated slot in said tubular body, said slot communicating with said storage volume, said storage volume adapted to receive a lottery ticket when said ticket is inserted into said slot; and
e. said tubular outer body having a removable and replaceable end cap providing access to said storage volume, said end cap adapted to be removed to allow withdrawal of said lottery tickets from said storage volume.

2. The combined writing and lottery ticket storing instrument of claim 1, comprising:
a pen cap removably engaged with said tubular outer body, said pen cap including a manually operable random number generator.

3. The combined writing and lottery ticket storing instrument of claim 2, wherein:
said pen cap includes a pocket clip, at least one end of said pocket clip comprising a scratch-off implement.

4. The combined writing and lottery ticket storing instrument of claim 2, wherein:
said pen cap frictionally engages with said tubular outer body through a removable snapping mechanism.

5. The combined writing and lottery ticket storing instrument of claim 1, wherein:
said tubular outer body is cylindrical.

6. The combined writing and lottery ticket storing instrument of claim 1, wherein:
said elongated slot has beveled surfaces.

7. The combined writing and lottery ticket storing instrument of claim 2, wherein:
said random number generator comprises a number panel displaying numbers.

8. The combined writing and lottery ticket storing instrument of claim 2, wherein:
said random number generator comprises a knurled wheel, said knurled wheel being able to be rotated in a counter clockwise or clockwise direction.

9. The combined writing and lottery ticket storing instrument of claim 2, wherein:
said pen cap comprises a number window revealing one selected number on said random number generator.

10. The combined writing and lottery ticket storing instrument of claim 9, wherein:
said number window is aligned with a magnifying lens to enlarge said selected number.

11. A method for aiding lottery purchasers with decision making and lottery ticket storing using a writing instrument, comprising:
a. spinning a knurled wheel of a random number generator to determine a number;
b. retrieving said determined number through a number reading window;
c. recording said determined number on at least one piece of paper; and
d. inserting said at least one piece of paper through a slot on the body of the writing instrument to securely store the at least one piece of paper in a storage volume inside said writing instrument .

12. The method of claim 11, further comprising:
turning the knurled wheel of a random number generator multiple times to display and determine multiple numbers as desired.

13. The method of claim 11, further comprising:
withdrawing a pen end cap to remove the paper stored in the storage volume.

14. The method of claim 11, further comprising:
inserting a gripping mechanism into the slot to engage the at least one piece of paper and remove said at least one piece of paper from said writing instrument.

15. The method of claim 11, further comprising:
scratching off covering material on a scratch lottery or card.

16. The method of claim 11, further comprising:
replacing an ink reservoir of said writing instrument.
